(19) United States
(12) Patent Application Publication
(10) Pub. No.: US 2003/0006077 A1
(43) Pub. Date: Jan. 9, 2003

(54) Apparatus and method of retarding a work machine

(76) Inventor: Jerry Francis Smith, Durham (GB)

Correspondence Address: CATERPILLAR INC., 100 N.E. ADAMS STREET, PATENT DEPT., PEORIA, IL, 616296490

(21) Appl. No.: 09/900,381

(22) Filed: Jul. 6, 2001

(51) Int. Cl. B62D 33/06; B62D 49/00

(52) U.S. Cl. 180/89.12; 180/311

(57) ABSTRACT

An apparatus and method of automatically controlling a retarding system for a work machine controlled by an operator is disclosed. An embodiment includes an automatic retarding system having a retarder control, a throttle sensor, a computer and a retarder valve assembly. Signals indicating the selected retarding mode and when the throttle is substantially deactivated are received and the retarder valve assembly controls the flow of hydraulic fluid to the retarder in response thereto.

### TECHNICAL FIELD

This invention relates generally to an apparatus and method of retarding a work machine and, more particularly, to automatically engaging a retarder when the throttle of the work machine is substantially deactivated.

### BACKGROUND

Load carrying work machines such as those used for transporting a loose load, for example, soil, rocks, gravel, garbage and the like from one location to another have a load carrying body for carrying the load. In some load carrying machines an ejector is provided for pushing the load from the load carrying body rather than dumping the load by tipping the load carrying body. These work machines are typically configured to perform various work cycles. For example, an articulated dump truck typically has a load carrying body for transporting a loose load from one point to another point. Often, the path over which the articulated dump truck must travel may vary in stability, composition and grade.

As a work machine performs work cycles, the machine must decelerate or control the rate of acceleration. For example, when approaching an intersection or passing median at which the machine must stop for other traffic or when traveling down a grade. In such instances, many articulated dump trucks use driveline retarding to assist the brakes with controlling or decelerating the load carrying machine. However, today, operators have to perform some additional task while controlling the machine during deceleration in order to engage or activate retarding. Performing these additional functions or acts could distract an inexperienced or fatigued operator.

Accordingly, the art has sought an apparatus and method of automatically controlling a retarding system for work machine controlled by an operator which: automatically senses a selected retarding mode; automatically senses when the throttle is substantially deactivated; automatically engages the retarder in response to sensing the retarding mode and deactivation of the throttle; may be used in a timely and efficient manner; and is more economical to manufacture and use.

The present invention is directed to overcoming one or more of the problems as set forth above.

### SUMMARY OF THE INVENTION

In an embodiment of the present invention an automatic retarding system for a work machine adapted to be controlled by an operator is provided. The system includes a retarder control, a throttle sensor, a computer and a retarder valve assembly. The retarder control is adapted to allow the operator to select a retarding mode and provide a control mode input signal in response to the selected retarding mode. The throttle sensor is adapted to sense when the throttle is substantially deactivated and provide a throttle input signal in response to sensing the throttle being substantially deactivated. The computer is adapted to receive the input signals and provide a valve control output signal in response to the input signals. The retarder valve assembly is adapted to receive the output signal and to provide fluid to the retarder in response to the output signal.

In an embodiment of the present invention a method of automatically controlling a retarding system for work machine controlled by an operator is provided. The method includes the steps of selecting a retarding mode, providing the control mode input signal in response to the step of selecting a retarding mode, sensing when the throttle is substantially deactivated, providing a throttle input signal in response to sensing the throttle being substantially deactivated, receiving the input signals, providing a valve control output signal in response to the input signals, receiving the output signal, and providing fluid to the retarder in response the output signal.

### BRIEF DESCRIPTION OF THE DRAWINGS

For a better understanding of the invention, reference may be made to the accompanying drawings in which:

FIG. 1 is a side view of a work machine of a preferred embodiment of the present invention;

FIG. 2 is a pictogram of a drive train of a work machine of a preferred embodiment of the present invention;

FIG. 3 is a block diagram of a automatic retarding system of the present invention; and

FIG. 4 is a flowchart of software logic implemented in an embodiment of the present invention.

### DETAILED DESCRIPTION

A preferred embodiment of the present invention provides an apparatus and method of automatically controlling a retarding system for a work machine 100 controlled by an operator. The following description uses an articulated truck as an example only. This invention may be applied to other types of work machines 100.

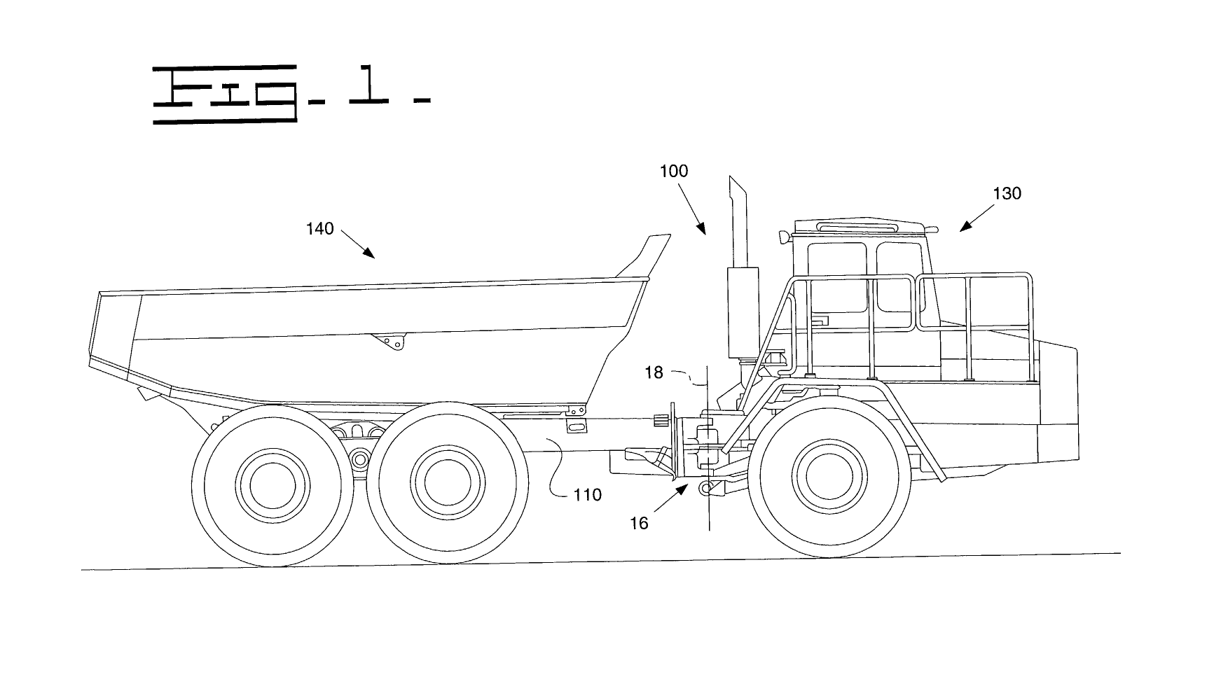

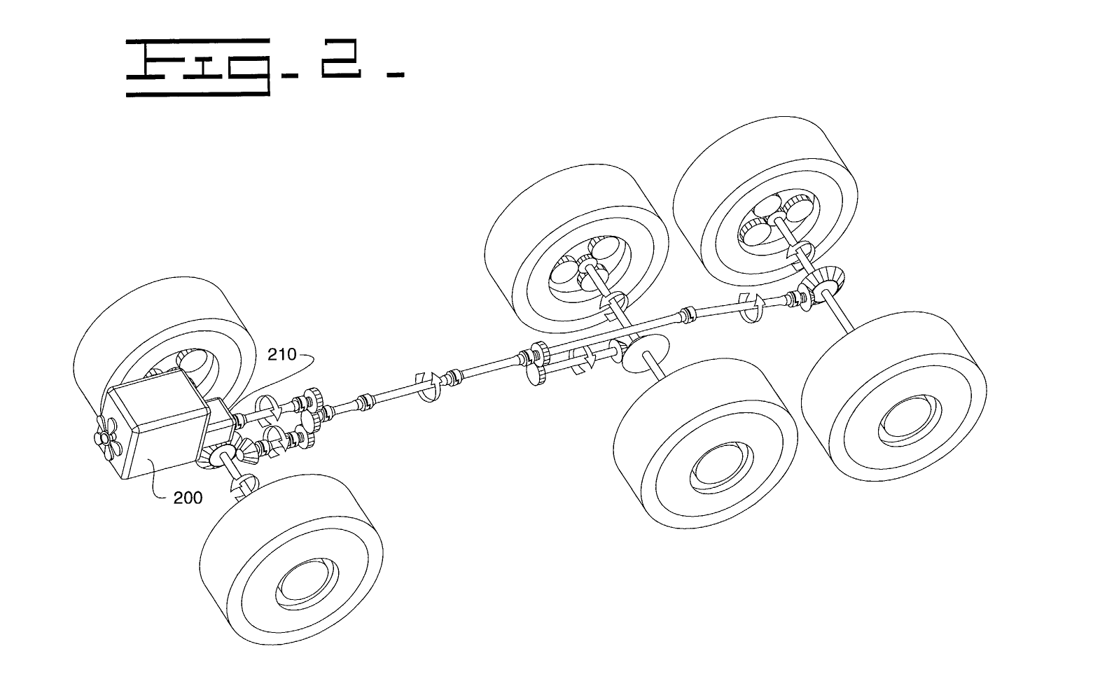

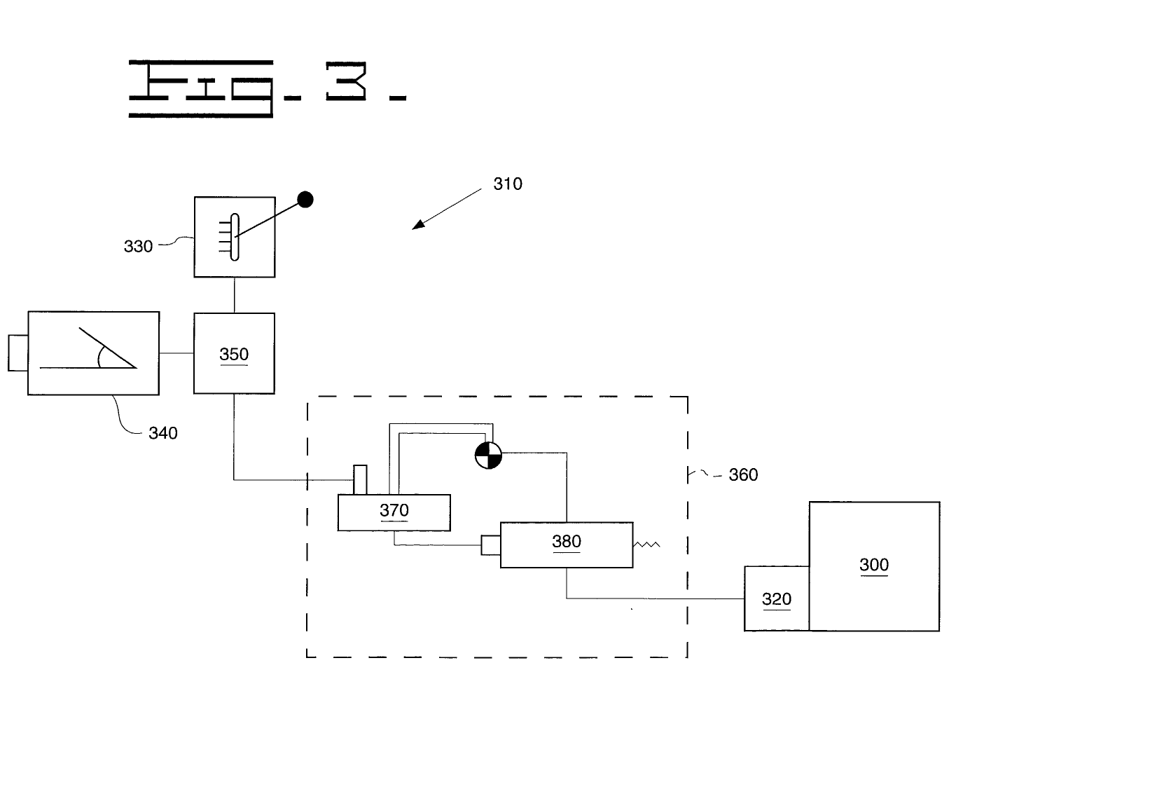

In FIG. 1, a load carrying work machine 100, shown as an articulated dump truck, has a frame 110, plurality of ground engaging devices 120, an operator compartment 130, a body 140, a torque converter 300 (FIG. 3), an engine 200 (FIG. 2) and an automatic retarding system 310 (FIG. 3).

The plurality of ground engaging devices 120 support the frame 110 and the operator compartment 130. The body 140 is preferably adapted to carry a load and has an assembly connecting the body 140 to the frame 110. The assembly for connecting the body 140 to the frame may be bolts, welds, slot and pin combinations, any of a number of fasteners for connecting the body 140 to the frame 110 as used in the art and preferably a pin joint and a displaced hydraulic cylinder such that a portion of the body 140 may be raised by the cylinder relative to the rest of the body 140 such that any load may be dumped out of the body 140.

The torque converter 300 has a fluid retarder 320 associated with it. Preferably, the torque converter 300 is operably coupled to the ground engaging devices 120 through a transmission 210. Engine 200 is coupled to the torque converter 300.

The automatic retarding system 310 includes a retarder control 330, a throttle sensor 340, a computer 350, and a retarder valve assembly 360.

The retarder control 330 is adapted to allow the operator to select a retarding mode. The retarding mode may be any of a number of possible forms of retarding such as on, off, low, medium, high, or any of a number of possible profiles varying the degree or amount of retarding. The retarder control 330 may be any of a number of operator interfaces including push-buttons, dip switches, touch screens, keypads, voice activated selection devices, or preferably, a manual selector switch. The retarder control 330 is adapted to provide a control mode input signal in response to the selected retarding mode. Advantageously, the control mode input signal is indicative of the selected retarding mode.

The throttle sensor 340 is adapted to sense when the throttle is substantially deactivated. The throttle sensor 340 may be one or more sensors such as position sensors, microswitches, optical or electrical wave sensing devices, doppler positioning devices, pressure devices, or preferably spring loaded pressure switch capable of determining when an operator has substantially stopped pressing the throttle which is preferably a fuel pedal. The throttle sensor 340 is adapted to provide a throttle input signal in response to sensing the throttle being substantially deactivated.

The computer 350 is adapted to receive the input signals and provide a valve control output signal in response to the input signals. Preferably, computer 350 is one of many readily available computers capable of processing numerous instructions. It should be appreciated that computer 350 may include multiple processing units configured in a distributed structure environment and forming a system.

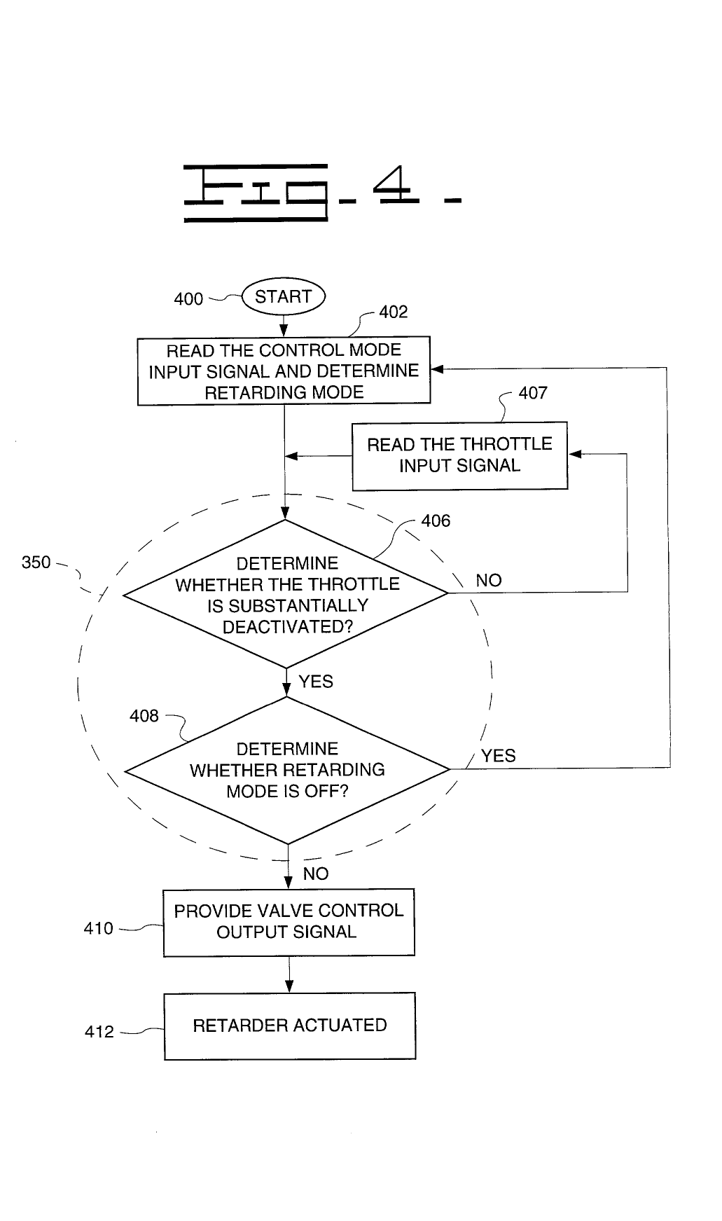

Referring now to FIG. 4, a flowchart of the software logic used in connection with the preferred embodiment is shown. Those skilled in the art can readily and easily write software implementing the flowchart shown in FIG. 4 using the instructions set, or other appropriate language associated with the particular microprocessor to be used.

First block 400 begins the program control. Program control passes from first block 400 to second block 402. In second block 402, the computer 350 reads the control mode input signal and determines the retarding mode. From second block 402, program control passes to the first decision block 406.

In first decision block 406, the computer 350 determines whether the throttle is substantially deactivated. If the throttle is not substantially deactivated control passes to the third block 407 where the computer 350 reads the throttle input signal and continues to pass control to the first decision block 406 until such time as the throttle is substantially deactivated. Upon receiving an affirmative indication that the throttle is substantially deactivated, control passes to the second decision block 408.

In second decision block 408, the computer 350 determines whether the retarding mode is off. If the computer 350 determines that the retarding mode is off control returns to the second block 402 and the aforementioned process is repeated. However, if the computer 350 determines that the retarding mode is not off control will then pass to the fourth block 410.

In fourth block 410, the computer 350 provides the valve control output signal which is used to actuate the retarder 320, in a manner to be described below, as depicted by fifth block 412. Advantageously, the output signal is a proportional signal that may vary depending upon the retarding mode sensed by the computer 350. As should be appreciated by those of ordinary skill in such art, the logic of FIG. 4 is performed frequently enough to provide the desired resolution and time responsiveness for retarding the work machine 100.

The retarder valve assembly 360 receives the output signal from the computer 350. Preferably, the retarder valve assembly 360 includes a pilot solenoid valve 370 adapted to receive the output signal and provide a pilot hydraulic signal to a spool 380. Spool 380 is preferably adapted to provide hydraulic fluid to retarder 320. Advantageously, pilot solenoid valve 370 and spool 380 are capable of providing hydraulic fluid flows to retarder 320 that are proportional to the input signal.

While aspects of the present invention have been particularly shown and described with reference to the preferred embodiment above, it will be understood by those skilled in the art that various additional embodiments may be contemplated without departing from the spirit and scope of the present invention. For example, such a automatic retarding system could be used with an electric motor driven drive train. However, any device or method incorporating such an embodiment should be understood to fall within the scope of the present invention as determined based upon the claims below and any equivalents thereof.

### INDUSTRIAL APPLICABILITY

Load carrying work machines such as those used for transporting a loose load, for example, soil, rocks, gravel, garbage and the like from one location to another perform various work cycles. As the work machine 100 performs these work cycles the operator typically uses brakes to decelerate and stop the machine.

However, due to the significant loads carried by such a work machine 100, often driveline retarding including a retarder 320 is utilized to assist with deceleration or stopping the work machine 100. This often results in reduced brake wear and helps prevent overheating of the brake system. In operation, an embodiment of the present invention senses an operation that must otherwise be performed by an operator. For example, it is preferable to sense the deactivation of the throttle. It should be appreciated that generally when an operator decelerates or stops a work machine 100 a necessary step is deactivating the throttle. Therefore, sensing the deactivation of the throttle to initiate retarding does not require any additional actions by the operator to engage retarding.

Depending on the work cycles being performed and the paths being traversed by the work machine 100 on a routine basis, an operator may desire to have different profiles of retarding corresponding to different degrees or amounts of retarding that assist with the deceleration and stopping of the work machine 100. Therefore, it is advantageous to provide a retarder control 330 adapted to allow the operator to select a retarding mode. This selection could be easily determined by the operator at some time other than when the operator is decelerating or stopping the work machine 100.

The apparatus and method of certain embodiments of the present invention, when compared with other methods and apparatus, may have the advantages of: automatically sensing a selected retarding mode; automatically sensing when the throttle is substantially deactivated; automatically engaging the retarder in response to sensing the retarding mode and deactivation of the throttle; being used in a timely and efficient manner; and being more economical to manufacture and use. Such advantages are particularly worthy of incorporating into the design, manufacture, and operation of work machines 100. In addition, the present invention may provide other advantages that have not been discovered yet.

It should be understood that while a preferred embodiment is described in connection with an articulated dump truck, the present invention is readily adaptable to provide similar functions for other work machines 100. Other aspects, objects, and advantages of the present invention can be obtained from a study of the drawings, the disclosure, and the appended claims.

What is claimed is:

1. A work machine adapted to be controlled by an operator and for acting upon a load through a plurality of work cycles, comprising:
a frame;
a plurality of ground engaging devices supporting the frame;
an operator compartment supported by the ground engaging devices;
a body adapted to carry a load and having an assembly for connecting the body to the frame;
a torque converter having a fluid retarder and being operably coupled to the ground engaging devices;
an engine coupled to the torque converter; and
an automatic retarding system including:
a retarder control adapted to allow the operator to select a retarding mode and provide a control mode input signal in response to the selected retarding mode;
a throttle sensor adapted to sense when the throttle is substantially deactivated and provide a throttle input signal in response to sensing the throttle being substantially deactivated;
a computer adapted to receive the input signals and provide a valve control output signal in response to the input signals; and
a retarder valve assembly for receiving the output signal and adapted to provide fluid to the retarder in response to the output signal.

2. The machine of claim 1, wherein the retarder control is adapted to allow the operator to select at least one of an off, on, low, medium or high retarding modes.

3. The machine of claim 1, wherein the output signal is a proportional signal and the valve assembly provides fluid to the retarder in proportion to the proportional signal.

4. An automatic retarding system for a work machine controlled by an operator comprising:
a retarder control adapted to allow the operator to select a retarding mode and provide a control mode input signal in response to the selected retarding mode;
a throttle sensor adapted to sense when the throttle is substantially deactivated and provide a throttle input signal in response to sensing the throttle being substantially deactivated;
a computer adapted to receive the input signals and provide a valve control output signal in response to the input signals; and
a retarder valve assembly for receiving the output signal and adapted to provide fluid to the retarder in response to the output signal.

5. The system of claim 4, wherein the retarder control is adapted to allow the operator to select at least one of an off, on, low, medium or high retarding modes.

6. The system of claim 4, wherein the output signal is a proportional signal and the valve provides fluid to the retarder in proportion to the proportional signal.

7. A method of automatically controlling a retarding system for a work machine controlled by an operator comprising:
selecting a retarding mode;
providing a control mode input signal in response to the step of selecting a retarding mode;
sensing when the throttle is substantially deactivated;
providing a throttle input signal;
providing a valve control output signal in response to the input signals; and
providing fluid to the retarder in response to the output signal.

8. The method of claim 7, wherein the step of selecting a retarder mode includes selecting at least one of an off, on, low, medium or high retarding modes.

9. The method of claim 7, wherein the output signal is a proportional signal and the step of providing fluid to the retarder in response to the output signal includes providing fluid to the retarder in proportion to the proportional signal.
